(19) United States
(12) Patent Application Publication
(10) Pub. No.: US 2011/0240701 A1
(43) Pub. Date: Oct. 6, 2011

(54) VEHICLE-MOUNTED ACCESSORY FIXTURE AND METHOD OF MOUNTING VEHICLE-MOUNTED ACCESSORY WITH THE FIXTURE

(75) Inventors: Tsutomu TOTANI, Aichi (JP); Yuichi Horiuchi, Aichi (JP)

(73) Assignee: Beat-Sonic Co., Ltd., Nisshin-shi (JP)

(21) Appl. No.: 12/835,131

(22) Filed: Jul. 13, 2010

(30) Foreign Application Priority Data
Mar. 30, 2010 (JP) 2010-076955

(51) Int. Cl. B60R 11/00; B23P 17/04

(52) U.S. Cl. 224/555; 29/428

(57) ABSTRACT

A vehicle-mounted accessory fixture is disclosed which mounts, at a predetermined position on a vehicle exterior, a vehicle-mounted accessory which is to be connected by a cable or the like to a vehicle-mounted electronic device installed in an interior of the vehicle. The fixture includes a bracket on which the vehicle-mounted accessory is mounted, the bracket having two ends, and a bolt which fixes the bracket to the vehicle exterior. The bracket has at one end a mounting portion on which the vehicle-mounted accessory is mounted and at the other end a through hole through which the bolt is inserted, and the bolt has a through hole which is formed so as to axially extend and which has such an inner diameter that the cable is loosely inserted through the through hole of the bolt.

### CROSS-REFERENCE TO RELATED APPLICATIONS

This application is based upon and claims the benefit of priority from the prior Japanese Patent Application No. 2010-76955, filed on Mar. 30, 2010, the entire contents of which are incorporated herein by reference.

### BACKGROUND

1. Technical Field

The present disclosure relates to a vehicle-mounted accessory fixture which is used to mount a vehicle-mounted accessory on a predetermined position of vehicle exterior, the accessory being connected to a vehicle-mounted electronic device installed in vehicle interior by a wireline such as cable, and a method of mounting the vehicle-mounted accessory with the fixture.

2. Related Art

Automobiles have recently been provided with various types of vehicle-mounted accessories which assist drivers and the like in driving. These vehicle-mounted accessories include a vehicle-mounted camera obtaining images of circumstances surrounding a vehicle, positioning lights signaling the presence of a vehicle, a proximity sensor preventing a vehicle body from collision against a wall, burner curb or the like and a radar or sonar maintaining a predetermined inter-vehicular distance. These vehicle-mounted accessories are connected by cable to in-vehicle electronic equipment such as a car navigation system or speed control device and mounted on respective predetermined vehicle exterior positions.

Japanese Patent Application Publication JP-A-2007-223342 discloses a rear monitor camera as one of the above-described vehicle-mounted accessories. The disclosed rear monitor camera is provided for imaging the rear of the vehicle and disposed in a recess formed in a part of the vehicle rear where a car number plate is mounted. As a result, the rear monitor camera can be prevented from protruding out of the body without degrading the vehicle design.

However, screw holes need to be provided in the vehicle body to fix the rear monitor camera when the rear monitor camera is mounted on the body. The screw holes leave traces thereof when the rear monitor camera is dismounted. This may reduce a trade-in price of the vehicle. Furthermore, each of the above-described vehicle-mounted accessories usually necessitates a series of mounting processes in which a mounting position is determined, screw holes are formed in the vehicle body and the vehicle-mounted accessory and the electronic device are connected to each other by cable. Since the mounting work is hard for an ordinary vehicle owner, the mounting work necessitates time and effort.

In view of the above-described problem, a vehicle-mounted camera A as shown in FIG. 5 is provided which denecessitates screw holes formed for mounting the camera A on the vehicle body and accordingly renders the mounting work easier. The vehicle-mounted camera A comprises a housing B in which a camera body is accommodated and a bolt C fixed to a rear face of the housing B. The bolt C has an axially extending through hole through which a cable D connected to the camera body is inserted. The bolt C is inserted through a hole used to fix a car number plate and then secured, whereby the vehicle-mounted camera A is mounted on a predetermined position on the car registration plate, as shown in FIG. 6.

The hole used to fix the car registration plate on the body is also used to mount the vehicle-mounted camera A as described above. This can eliminate provision of a new through hole for drawing the cable. Consequently, the vehicle owner can easily mount the vehicle-mounted camera A on the vehicle, and furthermore, a trade-in price of the vehicle can be prevented from reduction since no traces are left even when the vehicle-mounted camera A is dismounted.

In the above-described vehicle-mounted camera A, however, when the bolt C is inserted through the fixing hole of the car number plate and secured, the housing B is also rotated with the bolt C since the bolt C is fixed to the housing B. Accordingly, it is difficult to set the camera body accommodated in the housing B to a desired angle, whereupon the camera lens is displaced with respect to its vertical direction. As a result, there is a possibility that a correct image may not be displayed on the monitor screen.

Furthermore, the housing B protrudes from the surface of the car number plate to a large extent when the vehicle-mounted camera A has been mounted, whereupon the housing B is located near a light source for night-time illumination provided above an upper part of the car registration plate. This results in large shade on a number display portion D of the car number plate, as shown in FIG. 6. Since the housing B is formed integrally with the bolt C, the shade cannot be rendered smaller by adjusting the position of the vehicle-mounted camera A. Thus, there is a possibility that the number on the number display portion cannot easily be made out by the shade.

### SUMMARY

Therefore, an object of the present disclosure is to provide a vehicle-mounted accessory fixture which can allow the camera body or the like to be set to a desired angle and prevent the shade of the vehicle-mounted accessory from falling on the number display portion of the car number plate.

According to one aspect of the present disclosure, there is provided a vehicle-mounted accessory fixture for mounting, at a predetermined position on a vehicle exterior, a vehicle-mounted accessory which is to be connected by a cable or the like to a vehicle-mounted electronic device installed in an interior of the vehicle, the fixture comprising a bracket on which the vehicle-mounted accessory is mounted, the bracket having two ends, and a bolt which fixes the bracket to the vehicle exterior, wherein the bracket has at one end thereof a mounting portion on which the vehicle-mounted accessory is mounted and at the other end thereof a through hole through which the bolt is inserted, and the bolt has a through hole which is formed so as to axially extend and which has such an inner diameter that the cable is loosely inserted through the through hole of the bolt.

According to another aspect of the disclosure, there is provided a method of mounting a vehicle-mounted accessory at a predetermined location on a vehicle exterior using a vehicle-mounted accessory fixture, the vehicle-mounted accessory being connected by a cable or the like to a vehicle-mounted electronic device installed in an interior of the vehicle, the fixture comprising a bracket on which the vehicle-mounted accessory is mounted, the bracket having two ends and a bolt which fixes the bracket to the vehicle exterior, wherein the bracket has at one end thereof a mounting portion on which the vehicle-mounted accessory is mounted and at the other end thereof a through hole through which the bolt is inserted, and the bolt has a through hole which is formed so as to axially extend and which has such an inner diameter that the cable is loosely inserted through the through hole of the bolt, the method comprising mounting the vehicle-mounted accessory on the mounting portion of the bracket; loosely inserting the cable connected to the vehicle-mounted accessory through the through hole of the bolt and further inserting the bolt through the through hole of the bracket; and inserting the bolt through a hole which is provided on a vehicle body to fix a number plate, securing the bolt.

### BRIEF DESCRIPTION OF THE DRAWINGS

In the accompanying drawings:

FIG. 1 is a perspective view of a vehicle-mounted accessory fixture according to a first embodiment;

FIG. 2 is an exploded perspective view of the vehicle-mounted accessory fixture;

FIG. 3 is a schematic perspective view showing a number plate on which an accessory is mounted using the fixture;

FIG. 4 is a perspective view of a vehicle-mounted accessory fixture according to a second embodiment;

FIG. 5 is a perspective view of a conventional vehicle-mounted camera; and

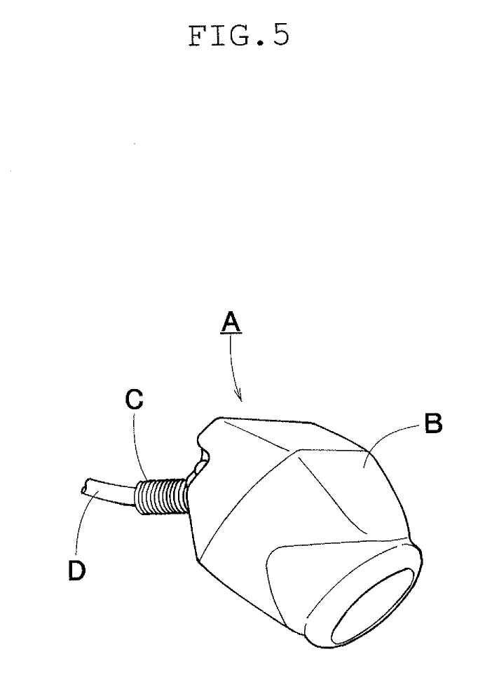

FIG. 6 is a schematic perspective view showing a number plate on which a vehicle-mounted camera is mounted in a conventional mounting method.

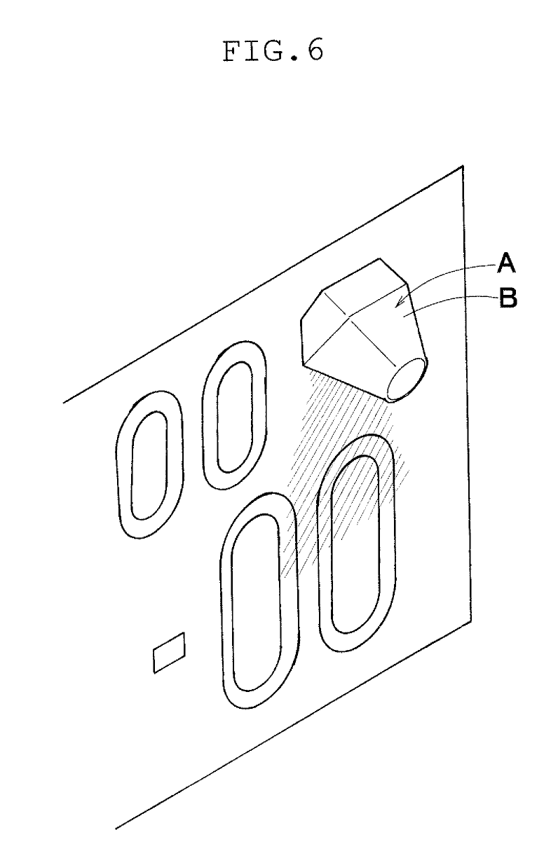

### DETAILED DESCRIPTION

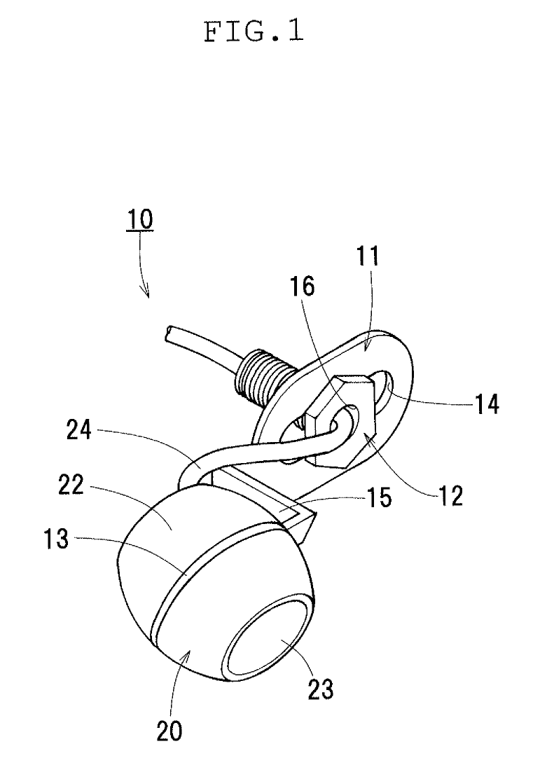

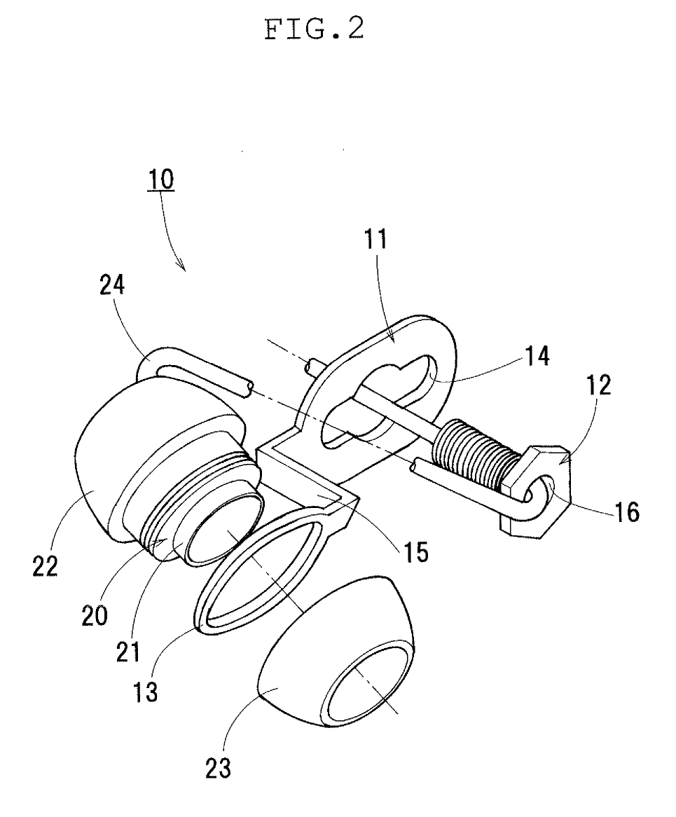

A vehicle-mounted accessory fixture according to a first embodiment will be described with reference to FIGS. 1 to 3. A vehicle-mounted accessory fixture 10 includes a bracket 11 and a bolt 12. The bracket 11 has an end on which a vehicle-mounted camera 20 exemplifying a vehicle-mounted accessory is mounted. The bracket 11 has two ends and includes a mounting portion 13 formed on one end thereof. The bracket 11 also has an elongate hole which is formed in the other end thereof so as to extend along the direction of elongation thereof and a generally cross-shaped hole 14 which comprises a hole located in a central part of the elongate hole and having an inner diameter substantially equal to the an outer diameter of the bolt 12. The bolt 12 is inserted through the cross-shaped hole 14. Although the hole through which the bolt 12 is inserted has a general cross shape in the embodiment, a horseshoe-shaped half hole may be provided in the other end of the bracket 11, instead.

The bracket 11 includes an intermediate part 15 having two ends each of which is bent into a general L-shape in planar view. As a result, since the mounting portion 13 is located outside the vehicle body relative to the hole 14, a vehicle-mounted camera 20 can be spaced from the vehicle body surface. Accordingly, the rear end of the vehicle-mounted camera 20 can be prevented from scrubbing the vehicle body thereby to damage the vehicle body. Furthermore, the intermediate part 15 of the bracket 11 is bent so that a proximal end of the mounting portion 13 is at a predetermined angle relative to the intermediate part 15 in planar view. Consequently, the vehicle-mounted camera 20 can be oriented to a desired direction.

The bolt 12 is a hexagon bolt formed with a through hole 16 extending axially. The hexagon bolt can be attached and detached by a commercially available tool. Accordingly, the vehicle-mounted camera 20 can easily mounted without a special tool. The through hole 16 has an inner diameter that is set so that a power supply/video output cable 24 which will be described later is loosely inserted through the hole 16. Accordingly, the power supply/video output cable 24 can smoothly be inserted through the hole 16.

The vehicle-mounted camera 20 includes a camera body 21, a housing 22, a lens hood 23 and the power supply/video output cable 24. The camera body 21 includes a lens (not shown) and an imaging device (not shown) and electrically converts a taken image to signals, which are delivered to a vehicle-mounted electronic device. The housing 22 accommodates the camera body 21 and a lens cover (not shown) made of hardened glass or acrylic is bonded to the front thereof. As a result, the lens of the camera body 21 can be protected, and the waterproof performance and the dust-proofness can be improved since the housing 22 is closely sealed by the lens cover. A male screw is provided near a lens cover.

The lens hood 23 has a female screw which is formed in the inside thereof so as to be brought into threading engagement with the aforesaid male screw of the housing 22. When the lens hood 23 is threadingly engaged with the housing 22, the mounting portion 13 is held between the lens hood 23 and the housing 22. Furthermore, the circumferential edge of the lens hood 23 can be prevented from deficit by the lens hood 23. The waterproof performance and the dust-proofness can further be improved by the lens hood 23 threadingly engaged with the housing 22. Furthermore, the housing 22 can be rotatively moved freely when the lens cover 23 is slightly loosened. As a result, the camera body 21 can easily be adjusted to a predetermined angle.

The power supply/video output cable 24 comprises a co-axial cable including a power supply line supplying power to the camera body 21 and a video output line which delivers an image from the camera body 21 to a video input terminal of the car navigation system, both lines being formed into a single cable. The power supply/video output cable 24 has an outer diameter smaller than an inner diameter of the through hole 16. Accordingly, the cable 24 can easily be inserted through the through hole 16 and drawn into the car interior. Thus, the vehicle-mounted camera 20 can easily be mounted on the vehicle. Furthermore, since the power supply/video output cable 24 is a single cable and inserted through the hole 16, the wiring around the vehicle-mounted camera 20 can be simplified and looks well. Still furthermore, the power supply/video output cable 24 is loosely inserted through the hole 16 as described above. As a result, even when the length of a part of the cable 24 exposed from the head of the bolt 12 changes in adjustment of the location of the camera body 21, the cable 24 can be prevented from being strained and from being disconnected.

The vehicle-mounted accessory fixed to the bracket 11 should not be limited to the above-described vehicle-mounted camera 20. The vehicle-mounted accessory fixed to the bracket 11 includes a lighting system 25 as will be described later, a proximity sensor preventing a vehicle body from collision against a wall, burrier curb or the like in the parking of a vehicle and a radar or sonar maintaining a predetermined inter-vehicular distance as well as the above-described vehicle-mounted camera 20. Each of these vehicle-mounted accessories is connected to a vehicle-mounted electronic device installed in the vehicle interior, for example, a car navigation system, alarming device or speed control device and is mounted at a predetermined location on a vehicle exterior.

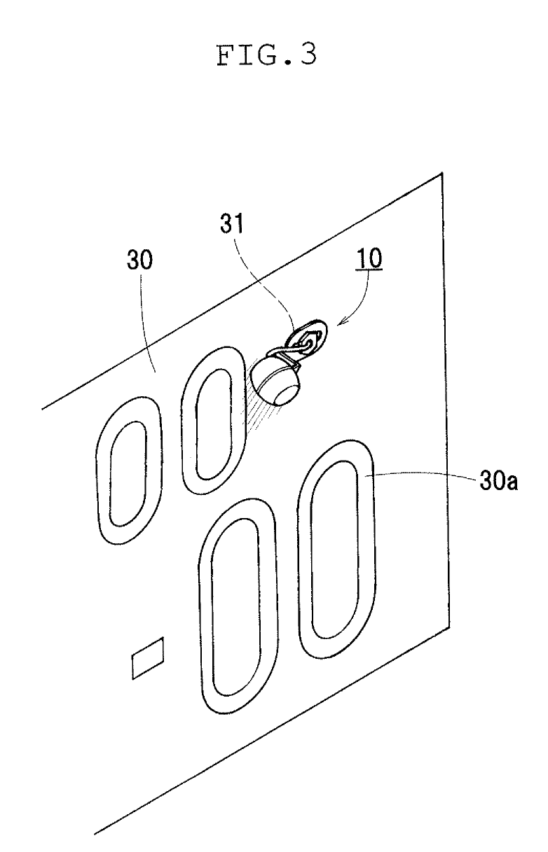

The fixture 10 for the vehicle-mounted accessory has the structure as described above. A method of mounting the vehicle-mounted accessory using the fixture 10 will now be described with reference to FIG. 3. A number plate 30 of the vehicle is generally fixed to the vehicle body by two bolts which are fastened through an upper part of the number plate. One of the bolts is sealed in order that falsification by replacement of the number plate may be prevented, whereas the other bolt is detachable. When the detachable bolt is removed, a hole 31 for fixing the number plate is provided in the number plate.

The bolt 12 is inserted through the hole 14 of the bracket 11 and the power supply/video output cable 24 is inserted through the hole 16. Thereafter, the bolt 12 is then inserted through the fixing hole 31 of the number plate 30. In this case, the bolt 12 may be threadingly engaged with a female thread formed in the inner circumferential surface of the hole 31 or with a nut in the back of the number plate 30. Consequently, the bracket 11 can be fixed to a predetermined location on the number plate 30. Since the power supply/video output cable 24 is inserted through the hole 16 of the bolt 12 in this case, the cable 24 can be drawn to the inside of the vehicle body without the vehicle body being bored. As a result, the vehicle-mounted camera 20 can easily be mounted.

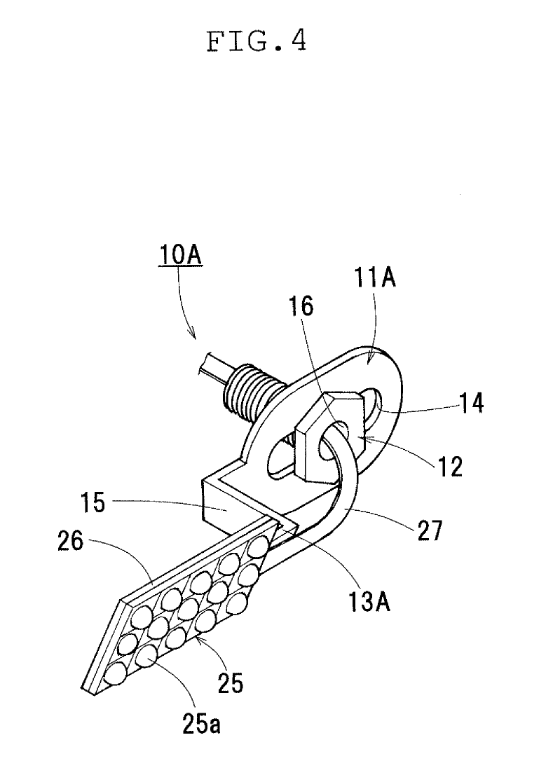

FIG. 4 illustrates a second embodiment in which a vehicle-mounted accessory is a lighting system. The fixture 10A for the vehicle-mounted accessory includes the bracket 11A and the bolt 12. A lighting device 25 as the vehicle-mounted accessory is mounted on an end of the bracket 11A. The mounting portion 13A on which the lighting device 25 is mounted is formed on the end of the bracket 11A. The other end of the bracket 11A has the elongate hole which is formed so as to extend along the direction of elongation thereof and the generally cross-shaped hole 14 which comprises the hole located in a central part of the elongate hole 14 and having the inner diameter substantially equal to the outer diameter of the bolt 12. Since the bracket 11A and the bolt 12 have the same structures in the other respects as in the previous embodiment respectively, further description of the bracket 11A and the bolt 12 will be eliminated.

The lighting device 25 mounted on the mounting portion 13A comprises a plurality of LEDs 25a and a substrate 26. An electrical circuit (not shown) is formed on the surface of the substrate 26. The LEDs 25a are arranged into the form of a matrix so as to be located at respective predetermined positions and then secured. Although a 3×5 matrix is exemplified as the arrangement of the LEDs 25a in the embodiment, the number of LEDs 25a may be increased or reduced according to an intended purpose. A power supply cable 27 is connected to the substrate 26 to supply power from a battery equipped on the vehicle to the lighting device 25. The power supply cable 27 is inserted through the hole 16 of the bolt 12 in the same manner as in the first embodiment.

Although the lighting device 25 comprises the LEDs 25a as the light source in the second embodiment, the lighting device may comprise electric lamps, fluorescent lamps or organic electroluminescent (EL) lamps.

The fixture 10A for the vehicle-mounted accessory according to the second embodiment has the structure as described above. Since the method of mounting the vehicle-mounted accessory using the fixture 10A is substantially the same as that in the first embodiment, the description of the mounting method will be eliminated.

According to the fixtures 10, 10A for the vehicle-mounted accessory, the hole 31 provided in the vehicle for fixing the number plate is also used to mount the vehicle-mounted accessory. Accordingly, the location for the vehicle-mounted accessory can easily be determined without hesitation. As a result, the vehicle-mounted accessory can promptly be mounted. Furthermore, the intermediate portion 15 of the bracket 11, 11A is bent so that the vehicle-mounted camera 20 or the lighting device 25 is spaced away from the fixing hole 31. Accordingly, the camera 20 or the lighting device 25 can be spaced away from the night-time illumination lamps. This can render a shade formed on the number plate 30 smaller.

Although the vehicle-mounted camera 20 and the lighting device 25 are mounted on different fixtures in the embodiment, both camera 20 and lighting device 25 may be mounted on the mounting portion 13 of a single bracket 11, 11A, for example. Furthermore, since the bracket 11, 11A comprises a thin plate, both fixtures 10 and 10A may be fixed by inserting a single bolt 12 through the fixing hole 31 for the number plate. Additionally, when the length of the intermediate portion 15 of the bracket 11 is increased, an optical axis of the lens can be located on a center line of the number plate, namely, moved closer to the center of the vehicle body than the conventional camera A. As a result, distortion of a taken image can be reduced.

The foregoing description and drawings are merely illustrative and are not to be construed in a limiting sense. Various changes and modifications will become apparent to those of ordinary skill in the art. All such changes and modifications are seen to fall within the scope as defined by the appended claims.

What is claimed is:

1. A vehicle-mounted accessory fixture for mounting, at a predetermined position on a vehicle exterior, a vehicle-mounted accessory which is to be connected by a cable or the like to a vehicle-mounted electronic device installed in an interior of the vehicle, the fixture comprising:
a bracket on which the vehicle-mounted accessory is mounted, the bracket having two ends; and
a bolt which fixes the bracket to the vehicle exterior, wherein the bracket has at one end thereof a mounting portion on which the vehicle-mounted accessory is mounted and at the other end thereof a through hole through which the bolt is inserted, and the bolt has a through hole which is formed so as to axially extend and which has such an inner diameter that the cable is loosely inserted through the through hole of the bolt.

2. The fixture according to claim 1, wherein the bracket includes an intermediate part which is bent so that the mounting portion of the bracket is located outward of the vehicle exterior relative to the hole of the bracket.

3. A method of mounting a vehicle-mounted accessory at a predetermined location on a vehicle exterior using a vehicle-mounted accessory fixture, the vehicle-mounted accessory being connected by a cable or the like to a vehicle-mounted electronic device installed in an interior of the vehicle, the fixture comprising a bracket on which the vehicle-mounted accessory is mounted, the bracket having two ends and a bolt which fixes the bracket to the vehicle exterior, wherein the bracket has at one end thereof a mounting portion on which the vehicle-mounted accessory is mounted and at the other end thereof a through hole through which the bolt is inserted, and the bolt has a through hole which is formed so as to axially extend and which has such an inner diameter that the cable is loosely inserted through the through hole of the bolt, the method comprising:
mounting the vehicle-mounted accessory on the mounting portion of the bracket;
loosely inserting the cable connected to the vehicle-mounted accessory through the through hole of the bolt and further inserting the bolt through the through hole of the bracket; and
inserting the bolt through a hole which is provided on a vehicle body to fix a number plate, securing the bolt.
